(19) United States
(12) Patent Application Publication
(10) Pub. No.: US 2015/0149132 A1
(43) Pub. Date: May 28, 2015

(54) TIME-STACKING METHOD FOR DYNAMIC SIMULATIONS

(71) Applicants: Zhenyu Huang, Richland, WA (US); Ruisheng Diao, Richland, WA (US); Di Wu, Richland, WA (US); Shuangshuang Jin, Issaquah, WA (US); Yu Zhang, Cordova, TN (US); Yousu Chen, Issaquah, WA (US); Bin Zheng, Richland, WA (US)

(72) Inventors: Zhenyu Huang, Richland, WA (US); Ruisheng Diao, Richland, WA (US); Di Wu, Richland, WA (US); Shuangshuang Jin, Issaquah, WA (US); Yu Zhang, Cordova, TN (US); Yousu Chen, Issaquah, WA (US); Bin Zheng, Richland, WA (US)

(73) Assignee: BATTELLE MEMORIAL INSTITUTE, Richland, WA (US)

(21) Appl. No.: 14/550,550

(22) Filed: Nov. 21, 2014

Related U.S. Application Data
(60) Provisional application No. 61/909,659, filed on Nov. 27, 2013.

(51) Int. Cl. G06F 17/50; G06F 17/13

(52) U.S. Cl. CPC G06F 17/5009; G06F 17/13
USPC 703/2

(57) ABSTRACT

A time-stacking method is disclosed. The time-stacking method simulates dynamics so as to obtain time-domain trajectories which correspond to a disturbance or event. The method includes providing a model for the system. The model includes differential equations and algebraic equations. The method also includes solving the differential equations and the algebraic equations over a predetermined number of time steps simultaneously using an implicit integration scheme.

### CROSS-REFERENCE TO RELATED APPLICATIONS

This application claims priority to U.S. Provisional Application Ser. No. 61/909,659, filed Nov. 27, 2013, titled “PARALLEL TIME-STACKING METHOD FOR LARGE-SCALE DYNAMIC SIMULATIONS,” hereby incorporated by reference in its entirety for all of its teachings.

### STATEMENT REGARDING FEDERALLY SPONSORED RESEARCH OR DEVELOPMENT

This invention was made with Government support under Contract DE-AC05-76RL01830 awarded by the U.S. Department of Energy. The Government has certain rights in the invention.

### TECHNICAL FIELD

This invention relates to dynamic simulations. More specifically, this invention relates to a time-stacking method of simulating dynamics of a system by solving multiple time steps simultaneously using an implicit integration scheme.

### BACKGROUND

Dynamic simulation plays a significant role in secure operations and planning of systems. In power networks, dynamic simulations solve a large set of differential algebraic equations for thousands of times that describe the electro-mechanical interaction of generators as well as power electronic devices and their controllers. The solutions of these equations determine the time-series trajectory of a power grid when subject to disturbances such as short-circuit faults, generator tripping, line switching or other severe contingencies.

The dynamics of a power system can be represented by a set of first-order differential equations (1a) and algebraic equations (1b):

$$\{ \begin{matrix}\dot{x} = f ( x , y ) \\ 0 = g ( x , y ) ( 1 b )\end{matrix} \qquad ( 1 a )$$

Where x represents a vector of state variables describing generator or load dynamics (e.g., generator rotor angle, rotor speed, sub-transient voltages or flux) and y represents a vector of algebraic variables (e.g., voltages from all or selected buses in the network and the current injections from generators or loads, which can be expressed as magnitudes and phase angles, or real and imaginary parts).

A major obstacle of introducing dynamic simulation into online security assessment is the computationally intensive time-domain solution of numerous differential and algebraic equations involved in modeling the system dynamics and network. The traditional method for dynamic simulation is serial in nature and can only solve the network dynamics one step after another. This process is very slow for a larger-scale power network model, such as the Western or Eastern Interconnection in North America.

A common serial dynamic simulation method is the partitioned or alternating solution. The partitioned-solution method is predominately used in industrial systems or commercial simulation software programs. In this method, the differential equation set of (1a) is discretized and then solved for x_{γ} (x at time step γ). The algebraic equation set (1b) is then solved for y_{γ}.

The partitioned-solution scheme includes an explicit integration method and an implicit integration for solving the equations, as shown in FIG. 1.

A. Partitioned Method with Explicit Integration

Using an explicit integration method, equation 1(a) is converted into an algebraic equation set

x_{γ}=F(x_{γ-1},y_{γ-1}). (2)

which can be used to solve for x_{γ} using the previous step values. The value of x_{γ} is used to solve (3) for y_{γ}.

0=g(x_{γ},y_{γ}). (3)

B. Partitioned Method with Implicit Integration

Using an implicit integration method, equation (1a) is converted into an algebraic equation set

x_{γ}=F(x_{γ},y_{γ}). (4)

The initial guess of x_{γ} can be obtained based on x_{γ-1} and y_{γ-1} using any explicit integration formula. The value of y_{γ} is then used in equation (4) to obtain x_{γ}, which is used in equation (3) to solve y_{γ}. This process will be repeated until the solution is converged.

### SUMMARY

The present invention describes methods of solving multiple time steps of system dynamics simultaneously so that the total computation time may be significantly reduced using parallel computing techniques. The method uses a single set of equations that models multiple time intervals simultaneously, which includes applying high-performance computing to solve the equations simultaneously in parallel.

In one embodiment of the present invention, a time-stacking method is disclosed. The time-stacking method simulates dynamics of a system to obtain time-domain trajectories of the system that correspond to a disturbance or event. The method includes a model for testing the system. The model includes differential equations and algebraic equations. The method also includes solving the differential equations and the algebraic equations over a predetermined number of time steps simultaneously using an implicit integration scheme. The method may also include applying a numerical solver to compute a final result of the equations. A supercomputer or high-performance computer may be applied for solving the equations simultaneously in parallel.

The implicit integration scheme includes, but is not limited to, at least one of the following: Backward Euler, Trapezoidal, Runge-Kutta, Newton, and Dishonest Newton.

The differential equations may represent vectors of state variables, and the algebraic equations may represent vectors of algebraic variables.

The vectors of state variables include, but are not limited to, generator and its controller dynamics. The generator dynamics may include rotor angle and generator speed.

The vectors of algebraic variables include, but are not limited to, voltages from all or selected buses in the network and the current injections from generators or loads, which can be expressed as magnitudes and phase angles, or real and imaginary parts.

In one embodiment, the time steps comprise intervals of at least 1 microsecond. The time steps of intervals may vary over a range of at least 1 microsecond so as to obtain a calculation that corresponds to the disturbance or event.

In another embodiment of the present invention, a method of simulating power system dynamics of a system so as to obtain time-domain trajectories which correspond to a disturbance or event is disclosed. The method includes providing a model for the system. The model includes differential equations and algebraic equations. The method further includes solving the differential equations and the algebraic equations over a predetermined number of time steps simultaneously using an implicit integration scheme. The method also includes applying a numerical solver to compute a final result of the equations, and applying a supercomputer or high-performance computer for solving the equations simultaneously.

### BRIEF DESCRIPTION OF THE DRAWINGS

FIG. 1 is a flow chart of a prior art partitioned-solution method using implicit or explicit methods, for simulating dynamics of a system.

FIG. 2 is a flow chart of a time-stacking method of simulating dynamics of a system so as to obtain time-domain trajectories which correspond to a disturbance or event, in accordance with one embodiment of the present invention.

FIG. 3A shows a Butcher tableau for an explicit Runge-Kutta integration method.

FIG. 3B shows a Butcher tableau for an implicit Runge-Kutta integration method.

FIG. 4 shows a Butcher tableau for a classical explicit Runge-Kutta integration method.

FIGS. 5A-5C shows stability domains for (A) Forward Euler, (B) Backward Euler, and (C) Trapezoidal integration methods.

FIG. 6 is a table showing the variables used in the code and the corresponding notation for a model for the system with a modified Euler integration method.

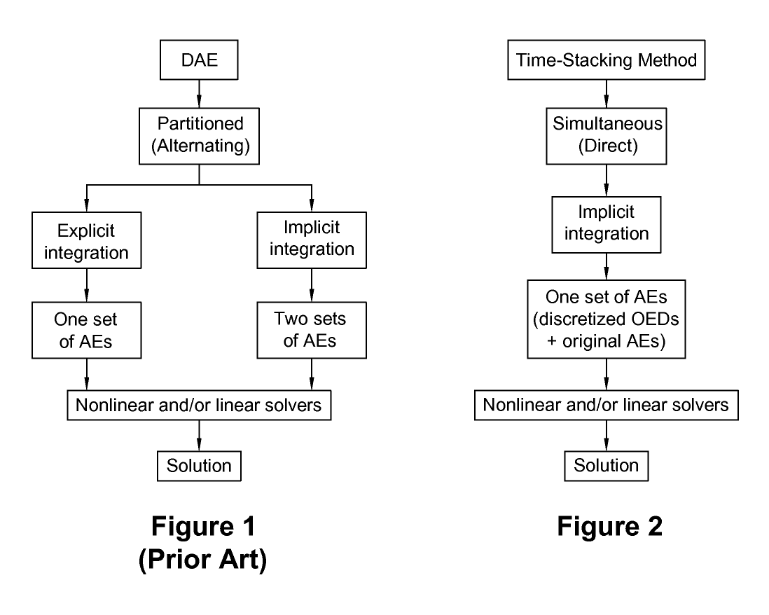

### DETAILED DESCRIPTION OF THE PREFERRED EMBODIMENTS

The present invention relates to time-stacking methods of solving multiple time steps of system dynamic performance simultaneously by using an implicit integration scheme. The present invention solves a single set of differential and algebraic equations simultaneously over a predetermined number of time steps. The parallel time-stacking methods solve multiple time steps simultaneously. As a result, the time-stacking methods of the present invention significantly speed up simulations of system performance.

In the simultaneous time-stacking method of the present invention, as shown in FIG. 2, equation (1a) is converted into a set of algebraic equations, which are lumped together with equation (1b) to form a single larger algebraic equations set. Variables X_{γ and} y_{γ} are solved simultaneously over a predetermined number of times steps using an implicit integration scheme. As an example, writing equation (4) in the form of

0=H(x_{γ},y_{γ}), (5)

and then combining equation (5) and equation (3), a single set of algebraic equations can be obtained. As one example, Newton's method can be used to solve the algebraic equation set, requiring the construction and solution at each iteration of the Jacobian matrix

$$J = [ \begin{matrix}{J}_{Fx} & {J}_{Fy} \\ {J}_{gx} & {J}_{gy}\end{matrix} ] . \qquad ( 6 )$$

No matter which scheme is used, those non-linear algebraic equations need to be solved using, for example, Gauss or Newton type procedures. Dishonest Newton or very dishonest Newton methods are often used in industrial software to increase computation speed. When Newton-like method is used, linear solvers are included as well.

Mathematic Formulation of Multi-Machine System with Classical Model

When generators are represented using the classical model, the equations of motion for generator i in per unit are:

$$\{ \begin{matrix}{\dot{δ}}_{( i )} = {ω}_{b} {ω}_{( i )} \\ {\dot{ω}}_{( i )} = \frac{1}{2 {H}_{( i )}} ( {P}_{m ( i )} - {P}_{e ( i )} - {D}_{( i )} {ω}_{( i )} ) ( 7 b )\end{matrix} \qquad ( 7 a )$$

where ω₍ᵢ₎ is the per unit speed deviation for generator i, δ₍ᵢ₎ is the angular position of the rotor of generator i in electrical radians with respect to a synchronously rotating reference, H₍ᵢ₎ is the inertia constant of generator i using system base VA², D₍ᵢ₎ is the damping factor or coefficient of generator i in pu torque/pu speed deviation, Pₘ₍ᵢ₎ is the mechanical power input of generator i, and ω_{b} is the base rotor electrical speed in radians per second. In this case, state variables in (1) only include rotor speed and angle, i.e.,

x=[δ₍₁₎,ω₍₁₎, . . . ,δ₍ᵢ₎,ω₍ᵢ₎, . . . ,δ₍ₙ₎,ω₍ₙ₎]^{T}, (8)

where n is the number of generators.

Using the classical model to study the transient stability for a multi-machine system, it is often assumed:

1) Mechanical power input (Pₘ₍ᵢ₎) is constant.

2) The mechanical rotor angle of a machine coincides with the angle of the voltage behind the transient reactance.

3) The network is assumed to be in the sinusoidal stead state.

4) Load is represented by the passive impedances, i.e., the dynamics of load is ignored.

Therefore, let Y″ (with a dimension equal to m by m) denote the nodal admittance matrix of an m-bus system comprised of n generator buses and m−n load buses. One can add machine internal buses and include load impedance into the admittance matrix, resulting in an extended Y-bus—Y′ (with a dimension equal to m+n by m+n). The network equation becomes:

$$[ \begin{matrix}{I}_{E} \\ 0\end{matrix} ] = {Y}^{′} [ \begin{matrix}E \\ V\end{matrix} ] . \qquad ( 9 )$$

The network equation can be reduced to

I_{E}=YE, (10)

where Y=Yₙₙ−Yₙₘ Y⁻¹ₘₘYₘₙ. Numerical evaluation of direct solvers for large sparse, symmetric linear equations could be used to solve Y⁻¹ₘₘYₘₙ. For each generator internal voltage bus i, the injection current in system reference can be expressed as

$${\overline{I}}_{( i )}^{sys} {=}^{Δ} {I}_{re ( i )} + j {I}_{im ( i )} = {\sum }_{k = 1}^{n} {\overline{Y}}_{( ik )} {\overline{E}}_{( k )} \qquad ( 11 )$$

where a bar above the notation represents a complex number, Ī^{sys}₍ᵢ₎ is the injection current of bus i in system reference, and Ē(k) is the stator internal voltage of bus k in system reference. Let Ē(k)=Eᵣₑ₍ₖ₎+jEᵢₘ₍ₖ₎ and Y̅₍ᵢₖ₎=G₍ᵢₖ₎+jB₍ᵢₖ₎, resolving (11) into real and imaginary part yields,

$$\begin{matrix}{I}_{re ( i )} = {\sum }_{k = 1}^{n} [ {E}_{re ( k )} {G}_{( ik )} - {E}_{im ( k )} {B}_{( ik )} ] , & ( 12 a ) \\ {I}_{im ( i )} = {\sum }_{k = 1}^{n} [ {E}_{re ( k )} {B}_{( ik )} - {E}_{im ( k )} {G}_{( ik )} ] . & ( 12 b )\end{matrix}$$

The transformation from machine dq0 reference frame to system reference frame is:

$$[ \begin{matrix}re \\ im\end{matrix} ] = [ \begin{matrix}sin δ & cos δ \\ - cos δ & sin δ\end{matrix} ] [ \begin{matrix}d \\ q\end{matrix} ] , \qquad ( 13 )$$

In classic model, since E′_{d}=0, applying the above transformation to Iᵣₑ, Iᵢₘ, Eᵣₑ, and Eᵢₘ in equation (12) and after manipulations, the following equations are obtained in machine reference frame:

$$\begin{matrix}0 = sin {δ}_{( i )} {I}_{d ( i )} + cos {δ}_{( i )} {I}_{q ( i )} - {\sum }_{k = 1}^{n} [ \begin{matrix}( cos {δ}_{( k )} {E}_{q ( k )}^{′} ) {G}_{( ik )} - \\ ( sin {δ}_{( k )} {E}_{q ( k )}^{′} ) {B}_{( ik )}\end{matrix} ] , & ( 14 a ) \\ 0 = - cos {δ}_{( i )} {I}_{d ( i )} + sin {δ}_{( i )} {I}_{q ( i )} - {\sum }_{k = 1}^{n} [ \begin{matrix}( cos {δ}_{( k )} {E}_{q ( k )}^{′} ) {B}_{( ik )} + \\ ( sin {δ}_{( k )} {E}_{q ( k )}^{′} ) {G}_{( ik )}\end{matrix} ] . & ( 14 b )\end{matrix}$$

The active power at air gap can be expressed as:

Pₑ₍ᵢ₎=E′_{q(i)}I_{q(i)}. (15)

Replacing Pₑ₍ᵢ₎ in equation (7) by equation (15) yields:

$$\{ \begin{matrix}{\dot{δ}}_{( i )} = {ω}_{b} {ω}_{( i )} \\ {\dot{ω}}_{( i )} = \frac{1}{2 {H}_{( i )}} ( {P}_{m ( i )} - {E}_{q ( i )}^{′} {I}_{q ( i )} - {D}_{( i )} {ω}_{( i )} ) ( 16 b )\end{matrix} \qquad ( 16 a )$$

Combining equation (16) and equation (14) results in a set of differential-algebraic equations (DAE) in the same form as equation (1), where:

x=[δ₍₁₎,ω₍₁₎, . . . ,δ₍ᵢ₎,ω₍ᵢ₎, . . . ,δ₍ₙ₎,ω₍ₙ₎]^{T}, (17)

y=[I_{d(1)},I_{q(1)}, . . . ,I_{d(i)},I_{q(i)}, . . . ,I_{d(n)},I_{q(n)}]^{T}, (18)

and the other notations represent parameters.

Numerical Integration Using Trapezoidal Method

The trapezoidal integration method is used in many time-domain simulation software and can be used to solve the classical model multi-machine system described above.

For time step γ, applying Trapezoidal rule to equation (16) and then combining the resulted algebraic equations with equation (14), yields:

$$\begin{matrix}\{ \begin{matrix}0 = {δ}_{( i , γ )} - {δ}_{( i , γ - 1 )} - \frac{h}{2} ( {ω}_{b} {ω}_{( i , γ - 1 )} + {ω}_{b} {ω}_{( i , γ )} ) \\ 0 = {ω}_{( i , γ )} - {ω}_{( i , γ - 1 )} - \frac{h}{2} [ \begin{matrix}\frac{1}{2 {H}_{( i )}} ( \begin{matrix}{P}_{m ( i , γ - 1 )} - {E}_{q ( i )}^{′} {I}_{q ( i , γ - 1 )} - \\ {D}_{( i )} {ω}_{( i , γ - 1 )}\end{matrix} ) + \\ \frac{1}{2 {H}_{( i )}} ( {P}_{m ( i , γ )} - {E}_{q ( i )}^{′} {I}_{q ( i , γ )} - {D}_{( i )} {ω}_{( i , γ )} )\end{matrix} ] ( 19 b ) \\ 0 = sin {δ}_{( i , γ )} {I}_{d ( i , γ )} + cos {δ}_{( i , γ )} {I}_{q ( i , γ )} - {\sum }_{k = 1}^{n} [ \begin{matrix}( cos {δ}_{( k , γ )} {E}_{q ( k )}^{′} ) {G}_{( i , k )} - \\ ( sin {δ}_{( k , γ )} {E}_{q ( k )}^{′} ) {B}_{( i , k )}\end{matrix} ] ( 19 c ) \\ 0 = - cos {δ}_{( i , γ )} {I}_{d ( i , γ )} + sin {δ}_{( i , γ )} {I}_{q ( i , γ )} - {\sum }_{k = 1}^{n} [ \begin{matrix}( cos {δ}_{( k , γ )} {E}_{q ( k )}^{′} ) {B}_{( i , k )} + \\ ( sin {δ}_{( k , γ )} {E}_{q ( k )}^{′} ) {G}_{( i , k )}\end{matrix} ] ( 19 d )\end{matrix} & ( 19 a )\end{matrix}$$

where h is the integration step length. The first two are corresponding to equations in F in equation (4); the last two are corresponding to equations in g in equation (3). Combining these equations results in:

$$0 = H ( {x}_{γ} , {y}_{γ} ) = [ \begin{matrix}{F}_{1} ( {x}_{γ} , {y}_{γ} ) \\ {F}_{2} ( {x}_{γ} , {y}_{γ} ) \\ … \\ {g}_{1} ( {x}_{γ} , {y}_{γ} ) \\ {g}_{2} ( {x}_{γ} , {y}_{γ} ) \\ …\end{matrix} ] , \\ where \\ {x}_{γ} = {[ {δ}_{( 1 , γ )} , {ω}_{( 1 , γ )} , … , {δ}_{( i , γ )} , {ω}_{( i , γ )} , … , {δ}_{( n , γ )} , {ω}_{( n , γ )} ]}^{T} \\ and \\ {y}_{γ} = [ {I}_{d ( 1 , γ )} , {I}_{q ( 1 , γ )} , … , {{I}_{d}}_{( i , γ )} , {{I}_{q}}_{( i , γ )} , … , {{I}_{d}}_{( n , γ )} , {{I}_{q}}_{( n , γ )} ] . \qquad ( 20 )$$

Both Newton and Gauss methods can be used to solve the equations.

1) Newton: In order to solve the equation using Newton method, one needs to find the Jacobian Matrix first. The Jacobian matrix of equation (6), restated here for convenience, is:

$$J = [ \begin{matrix}{J}_{Fx} & {J}_{Fy} \\ {J}_{gx} & {J}_{gy}\end{matrix} ] . \qquad ( 21 )$$

Each sub-matrix is calculated below:

$$\begin{matrix}{J}_{Fx} = diag ( {J}_{Fx}^{i} ) and {J}_{Fx}^{i} = [ \begin{matrix}1 & - h {ω}_{b} / 2 \\ 0 & 1 + {hD}_{( i )} / ( 4 {H}_{( i )} )\end{matrix} ] . & ( 22 ) \\ {J}_{Fy} = diag ( {J}_{Fy}^{i} ) and {J}_{Fy}^{i} = [ \begin{matrix}0 & 0 \\ 0 & {hE}_{q ( i )}^{′} / ( 4 {H}_{( i )} )\end{matrix} ] . & ( 23 ) \\ {J}_{gx} {J}_{gx} = [ \begin{matrix}{J}_{gx ( 11 )} & {J}_{gx ( 12 )} & … & {J}_{gx ( 1 n )} \\ {J}_{gx ( 21 )} & {J}_{gx ( 22 )} & … & {J}_{gx ( 2 n )} \\ ⋮ & ⋮ & ⋱ & ⋮ \\ {J}_{gx ( n 1 )} & {J}_{gx ( n 2 )} & … & {J}_{gx ( nn )}\end{matrix} ] & ( 24 ) \\ {J}_{gx ( ii )} = [ \begin{matrix}\begin{matrix}{I}_{d ( i , γ )} cos {δ}_{( i , γ )} - {I}_{q ( i , γ )} sin {δ}_{( i , γ )} + \\ {G}_{( ii )} {E}_{q ( i )}^{′} sin {δ}_{( i , γ )} + {B}_{( i , i )} {E}_{q ( i )}^{′} cos {δ}_{( i , γ )}\end{matrix} & 0 \\ \begin{matrix}{I}_{d ( i , γ )} sin {δ}_{( i , γ )} + {I}_{q ( i , γ )} cos {δ}_{( i , γ )} + \\ {B}_{( ii )} {E}_{q ( i )}^{′} sin {δ}_{( i , γ )} - {G}_{( i , i )} {E}_{q ( i )}^{′} cos {δ}_{( i , γ )}\end{matrix} & 0\end{matrix} ] . & ( 25 ) \\ {J}_{gx ( ik )} = [ \begin{matrix}{G}_{( i , k )} {E}_{q ( k )}^{′} sin {δ}_{( k , γ )} + {B}_{( i , k )} {E}_{q ( k )}^{′} cos {δ}_{( k , γ )} & 0 \\ {B}_{( i , k )} {E}_{q ( k )}^{′} sin {δ}_{( k , γ )} - {G}_{( i , k )} {E}_{q ( k )}^{′} cos {δ}_{( k , γ )} & 0\end{matrix} ] . & ( 26 ) \\ {J}_{gy} = diag ( {J}_{gy}^{i} ) and {J}_{gy}^{i} = [ \begin{matrix}sin {δ}_{( i , γ )} & cos {δ}_{( i , γ )} \\ - cos {δ}_{( i , γ )} & sin {δ}_{( i , γ )}\end{matrix} ] . & ( 27 )\end{matrix}$$

Similarly, one can find the analytical expression of Jacobian matrix when higher order machine model and dynamic load model are used. Among the reviewed the references, no one suggests that there exists any difficulty to find the analytical expression of Jacobian matrix. The method to find Jacobian matrix in general case (rather than classic machine model and constant impedance) is described in equation [6]. In equations [26] and [27], the analytical expression of the Jacobian matrix is provided when transient machine model, exciter model, and dynamic load model are used.

2) Gauss: Rearranging equation (19) in the form:

X_{γ}=G(X_{γ}), (28)

the equation can be directly solved using Gauss or Gauss-Seidel method.

Time Stacking Method—Parallel in Time

In this method, in one embodiment, the equations in (20) are combined to form a large set of algebraic equations:

$$\{ \begin{matrix}0 = H ( {x}_{γ} , {y}_{γ} ) \\ 0 = {H}^{′} ( {x}_{γ} , {y}_{γ} , {x}_{γ + 1} , {y}_{γ + 1} ) \\ … \\ 0 = {H}^{′} ( {x}_{γ + p - 2} , {y}_{γ + p - 2} , {x}_{γ + p - 1} , {y}_{γ + p - 1} )\end{matrix} \qquad ( 29 )$$

where p represents the number of time steps in parallel, and H and H′ are comprised of equations similar to (19). In H, the previous time step variables are known and the only unknown are the current time step variables. In H′, variables of two future adjacent time steps are unknown. The variables to be determined are:

[(x_{γ},y_{γ}),(x_{γ+1},y_{γ+1}), . . . ,(x_{γ+p-1},y_{γ+p-1})].

This equation set can be solved similarly as a conventional one-step approach. The corresponding Jacobian matrix is

$$Λ = [ \begin{matrix}{J}_{γ} & 0 & … & 0 & 0 \\ {J}_{( γ + 1 , γ )} & {J}_{γ + 1} & … & 0 & 0 \\ ⋮ & ⋮ & ⋱ & ⋮ & ⋮ \\ 0 & 0 & … & {J}_{( γ + p - 1 , γ + p - 2 )} & {J}_{γ + p - 1}\end{matrix} ] \qquad ( 30 )$$

where the diagonal sub-matrix is shown in equation (21). In the subscript of the off-diagonal matrix, the first number represents the equation set index, and the second number represents variable set index.

$${J}_{( j + 1 , i )} = [ \begin{matrix}{J}_{{F}_{j + 1} {x}_{j}} & {J}_{{F}_{j + 1} {y}_{j}} \\ 0 & 0\end{matrix} ] , \qquad ( 31 )$$

where j=γ, γ+1, . . . , γ+p−2. Each sub-matrix is calculated below:

$$\begin{matrix} {J}_{{F}_{j + 1} {x}_{j}} = diag ( {J}_{{F}_{j + 1} {x}_{j}}^{i} ) \\ and \\ {J}_{{F}_{j + 1} {x}_{j}}^{i} = [ \begin{matrix}- 1 & - h {ω}_{b} / 2 \\ 0 & - 1 + {hD}_{( i )} / ( 4 {H}_{( i )} )\end{matrix} ] . & ( 32 ) \\ {J}_{{F}_{j + 1} {y}_{j}} = diag ( {J}_{{F}_{j + 1} {y}_{j}}^{i} ) \\ and \\ {J}_{{F}_{j + 1} {y}_{j}}^{i} = [ \begin{matrix}0 & 0 \\ 0 & h \text{?} / ( 4 {H}_{( i )} )\end{matrix} ] . \\ \text{?} \text{indicates text missing or illegible when filed} & ( 33 )\end{matrix}$$

Numerical integration methods can be categorized by two attributes: 1) single-step or multi-step; 2) explicit or implicit.

1) Single-step methods only utilize one previous point and its derivative to determine the value at current step. On the other hand, multi-step methods express the value at current step as a function of the previous points and their derivative values. Runge-Kutta (RK) methods are the most famous family of single-step methods, while Adams family is the best known multi-step methods.

2) Explicit methods evaluate the value of current step explicitly as a function of values at previous steps, while implicit methods expresses the value at current step as a function of values at both current and previous steps.

Runge-Kutta and Adams (both explicit and implicit) methods will be briefly described below.

A. Runge-Kutta Methods

For an ordinary differential equation \dot{x}=f(x), RK methods have the form:

$${x}_{n + 1} = {x}_{n} + {\sum }_{i = 1}^{s} {b}_{i} {K}_{i ,} \qquad ( 34 )$$

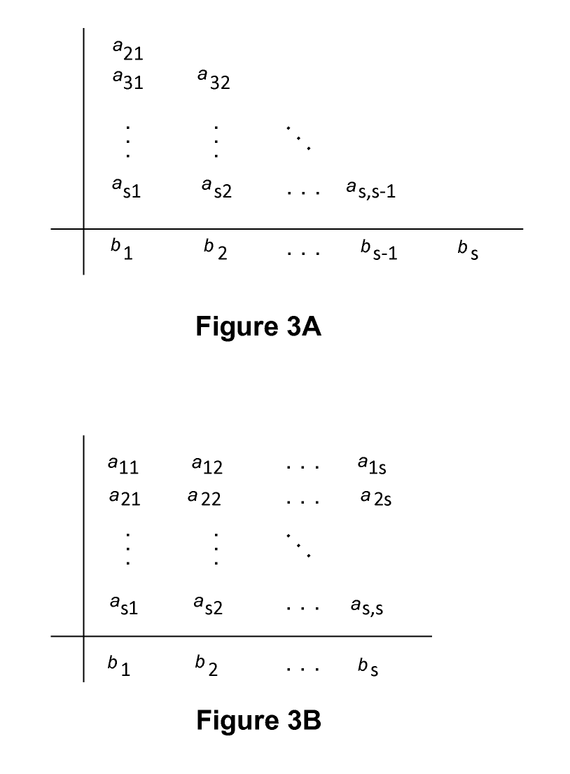

The Butcher tableaus for explicit and implicit RK methods are shown in FIGS. 3A and 3B, respectively.

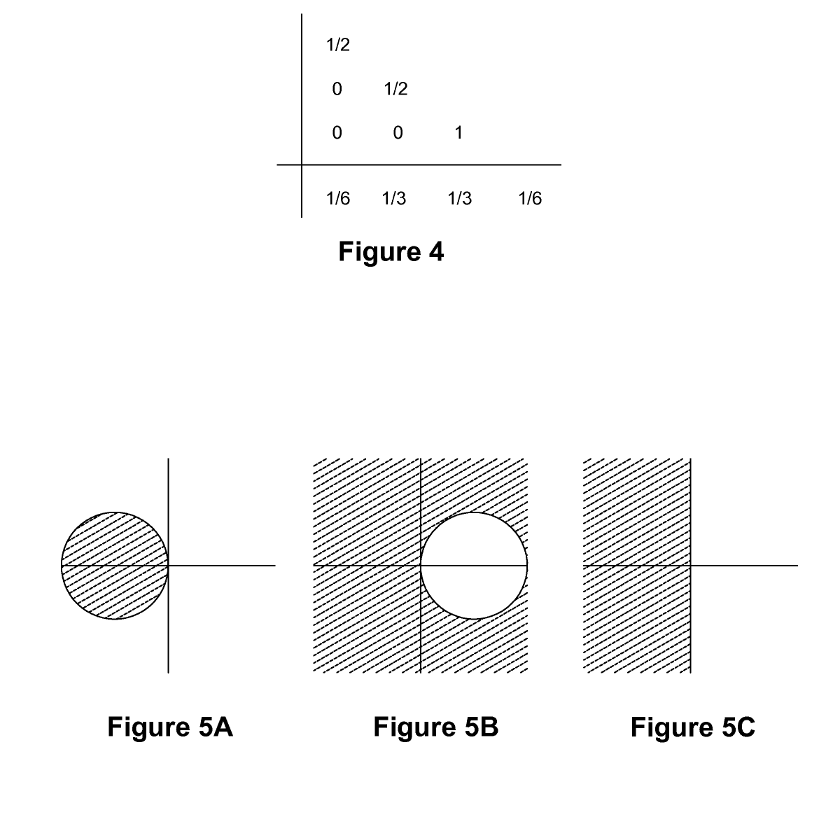

1) Examples of Explicit RK Methods:
Forward Euler is the simplest explicit RK method with s=1 and b1=1. Its formula is xₙ₊₁=xₙ+hf(xₙ).
One of the family of Runge-Kutta methods is so commonly used that it is often referred to as “RK4”, “classical Runge-Kutta”, or simply as “the Runge-Kutta method”. Its Butcher tableau is shown in FIG. 4.

2) Examples of Implicit RK Methods:
The simplest example of an implicit RK method is the backward Euler method.
Trapezoidal method is the second order implicit RK method.

B. Adams Methods

Adams methods have the form:

$${\sum }_{k = 0}^{s} {α}_{k} {x}_{n + k} = h {\sum }_{k = 0}^{s} {β}_{k} f ( {x}_{n + k} ) . \qquad ( 35 )$$

For Adams-Bashforth (explicit Adams methods), β=0; for Adams-Moulton (implicit Adams methods), β≠0.

Multi-step methods attempt to gain efficiency by keeping and using the information from previous steps rather than discarding it. For example, the formula of two-step Adams-Bashforth method is

$$\begin{matrix}{x}_{n + 1} = {x}_{n} + \frac{h}{2} [ 3 f ( {x}_{n} ) - f ( {x}_{n - 1} ) ] \\ = {x}_{n} + hf ( {x}_{n} ) + \frac{{h}^{2}}{2} \underbrace{\frac{f ( {x}_{n} ) - f ( {x}_{n - 1} )}{h}}_{{f}^{′} ( {x}_{n} ) + O ( h )} \\ = {x}_{n} + hf ( {x}_{n} ) + \frac{{h}^{2}}{2} {f}^{′} ( {x}_{n} ) + O ( {h}^{3} ) .\end{matrix} \qquad ( 36 )$$

Therefore, two-step Adams-Bashforth is equivalent to considering up to the second derivative term in the Taylor series. It should be noted that idea of multi-step integration methods is not approximating the first-order derivative at current step by combination of first-order derivative at previous steps. Instead, the method utilizes the information at previous steps to obtain a higher order approximation of Taylor series. One disadvantage of multi-step methods is the integration process has to be restarted whenever a discontinuity occurs.

Forward Euler, backward Euler, and Trapezoidal methods are degenerate cases of Adams methods, which only utilize one previous point and its derivate to determine the value at a current step.

Numerical Instability and Hyper-Stability

A numerical integration method is chosen so that:
if the continuous system is stable, the discrete time system is also stable.
if the continuous time system is unstable, the discrete time system is also unstable.

However, an integration method may create numerical instability, i.e., the continuous time system is stable, but the discrete time system is unstable. On the other hand, an integration method may also create hyper-stability, i.e., the continuous time system is unstable, but the discrete time is stable. Forward Euler, backward Euler, and Trapezoidal methods will be used to explain the idea of the above concepts.

A. Forward Euler

Let H(s) and H(z) denote the s-domain (corresponding to continuous time) and z-domain (corresponding to discrete time) transfer functions, respectively. Let sₚ=σₚ+jωₚ denote a pole of H(s). The continuous time system is stable if σₚ<0, for all the poles of H(s). The discrete system is stable when |zₚ|<1 for all the poles of H(z). The z-domain transfer function using forward Euler integration can be obtained by

$$H ( z ) = H ( s ) {\vert}_{s = \frac{x - 1}{h}} . \qquad ( 37 )$$

The poles of H(z) can be obtained by zₚ=1+hsₚ.

When the continuous system is unstable, i.e., there exists at least one pole with σₚ>0, then:

|zₚ|=\sqrt{(1+hσₚ)²+(hωₚ)²}≦1, ∀h≦0. (38)

Therefore the discrete system is unstable, which means forward Euler does not create hyper-stability.

When the continuous system is stable, i.e., σₚ<0 for all the poles H(s), then:

$$\begin{matrix}\vert {z}_{p} \vert = \sqrt{{( 1 + h {σ}_{p} )}^{2} + {( h {ω}_{p} )}^{2}} \\ = \sqrt{1 + h ( {σ}_{p}^{2} + {ω}_{p}^{2} ) ( h + \frac{2 {σ}_{p}}{{σ}_{p}^{2} + {ω}_{p}^{2}} )}\end{matrix} > 1 , \\ when \\ h > \frac{- 2 {σ}_{p}}{{σ}_{p}^{2} + {ω}_{p}^{2}} ( i . e . , \vert 1 + {hs}_{p} \vert > 1 ) , \qquad ( 39 )$$

which means when integration step length h is not small enough, forward Euler will cause numerical instability.

Defining R(hs) [symbol] R as stability function of integration method, then the stability domain is

S={μεC,|R(μ)|≦1}. (40)

The stability function of forward Euler is

R(μ)=1+μ. (41)

Its stability domain is shown in FIG. 5A.

B. Backward Euler

The stability function of backward Euler is

$$R ( μ ) = \frac{1}{1 - μ} . \qquad ( 42 )$$

Its stability domain is shown in FIG. 5B.

When the continuous system is stable, i.e., σₚ<0 for all the poles of H(s), μ falls in the stability region for any integration time step length. Therefore, the discrete time system is stable, which means backward Euler method does not create numerical instability.

When the continuous system is unstable, i.e., there exists at least one pole with σₚ>0, the corresponding μₚ=hsₚ falls in the stability region when h>2σₚ/(σ²ₚ+w²ₚ) (i.e., |h sₚ−1|>1), which means the discrete time system is stable. Therefore, backward Euler may create hyper-stability.

C. Trapezoidal

The stability function of forward Euler is

$$R ( μ ) = \frac{1 + μ / 2}{1 - μ / 2} . \qquad ( 43 )$$

Its stability domain is shown in FIG. 5C. As can be seen, the stability property of the discrete time system is exactly the same as the continuous time system for all the time step length, i.e., the Trapezoidal method avoids both numerical instability and hyper-stability.

Classical Model with Modified Euler Method

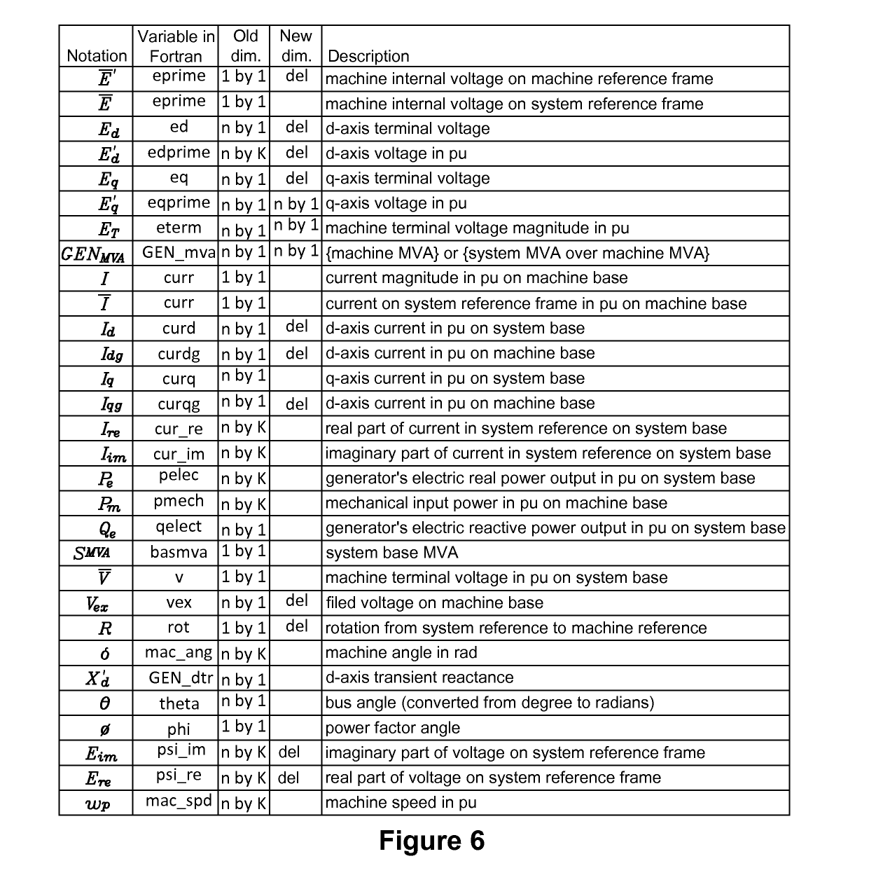

The variables used in the code and the corresponding notation herein are listed in the table of FIG. 6. The equations are provided based on which existing code is developed.

A. Equations Translated Back from Existing Code

For each generator at time step 1 (main):

$$\begin{matrix} & {GEN}_{MVA ( i )} ← \frac{{S}_{MVA}}{{GEN}_{MVA ( i )}} & \\ & \overline{V} = {E}_{T ( i )} {e}^{j {θ}_{( i )}} & \\ I = \sqrt{{P}_{e ( i , 1 )}^{2} + {Q}_{e ( i )}^{2}} / {E}_{T ( i )} \times & φ = {tan}^{- 1} ( \frac{{Q}_{e ( i )}}{{P}_{e ( i , 1 )}} ) & \overline{I} = I {e}^{j ( {θ}_{( i )} - φ )} \\ {GEN}_{MVA ( i )} & & \\ \overline{E} = \overline{V} + {jX}_{d ( i )}^{′} \overline{I} & {E}_{im} = imag ( \overline{E} ) & {E}_{re} = real ( \overline{E} ) \\ {δ}_{( i , 1 )} = {tan}^{- 1} ( \frac{imag ( \overline{E} )}{real ( \overline{E} )} ) & {ω}_{( i , 1 )}^{p} = 1 & \\ & ℛ = {je}^{- {jδ}_{( i , 1 )}} {=}^{Δ} {e}^{j ( 90 ° - {δ}_{( i , 1 )} )} & \\ {\overline{E}}^{′} = \overline{E} ℛ & {E}_{d ( i , 1 )}^{′} = real ( {E}^{′} ) & {E}_{q ( i , 1 )}^{′} = imag ( {E}^{′} ) \\ \overline{I} ← \overline{I} ℛ & {I}_{dg ( i )} = real ( I ) & {I}_{qg ( i )} = imag ( I ) \\ & {I}_{d ( i )} = real ( I ) / {GEN}_{MVA ( i )} & {I}_{q ( i )} = imag ( I ) / \\ & & {GEN}_{MVA ( i )} \\ \overline{V} ← \overline{V} ℛ & {E}_{d ( i )} = real ( \overline{V} ) & {E}_{q ( i )} = imag ( \overline{V} ) \\ & {V}_{ex ( i )} = {E}_{q ( i , 1 )}^{′} & \\ & {P}_{m ( i , 1 )} = {P}_{e ( i , 1 )} {GEN}_{MVA ( i )} & \end{matrix}$$

For each time step γ, for each generator i:

P_{m(i,γ+1)}=P_{m(i,γ)}

mac_em1 (machine to system reference frame):

E_{re(i,γ)}=sin δ_{(i,γ)}E′_{d(i,γ)}+cos δ_{(i,γ)}E′_{q(i,γ)} [symbol] real[ E̅′̅_{(i,γ)}/R_{(i,γ)}]

E_{im(i,γ)}=−cos δ_{(i,γ)}E′_{d(i,γ)}+sin δ_{(i,γ)}E′_{q(i,γ)} [symbol] imag[ E̅′̅_{(i,γ)}/R_{(i,γ)}]

After terminal voltage Ē(_{i,γ}) is obtained for all the buses, for each generator i:

i_simu_innerloop2 (system reference frame):

$${\overline{I}}_{( i , γ )} = {\sum }_{k} {\overline{Y}}_{( ik )} {\overline{E}}_{( k , γ )}$$

$${I}_{re ( i , γ )} = real [ {\overline{I}}_{( i , γ )} ]$$

$${I}_{im ( i , γ )} = imag [ {\overline{I}}_{( i , γ )} ]$$

mac_em2 (system to machine reference frame):

$${I}_{d ( i )} = sin {δ}_{( i , γ )} {I}_{re ( i , γ )} - cos {δ}_{( i , γ )} {I}_{im ( i , γ )} {=}^{Δ} real [ {\overline{I}}_{( i , γ )} {ℛ}_{( i , γ )} ] \\ {I}_{q ( i )} = cos {δ}_{( i , γ )} {I}_{re ( i , γ )} + sin {δ}_{( i , γ )} {I}_{im ( i , γ )} {=}^{Δ} imag [ {\overline{I}}_{( i , γ )} {ℛ}_{( i , γ )} ] \\ \begin{matrix}{I}_{dg ( i )} = {I}_{d ( i )} {GEN}_{MVA ( i )} & {I}_{qg ( i )} = {I}_{q ( i )} {GEN}_{MVA ( i )} & \\ {E}_{d ( i )} = {E}_{d ( i , γ )}^{′} + & {E}_{q ( i )} = {E}_{q ( i , γ )}^{′} - & {E}_{T ( i )} = \sqrt{{E}_{d ( i )}^{2} + {E}_{q ( i )}^{2}} \\ {X}_{d ( i )}^{′} {I}_{qg ( i )} & {X}_{d ( i )}^{′} {I}_{dg ( i )} & \\ {P}_{e ( i , γ )} = {E}_{q ( i )} {I}_{q ( i )} + & {Q}_{e ( i , γ )} = {E}_{q ( i )} {I}_{d ( i )} - & \\ {E}_{d ( i )} {I}_{d ( i )} & {E}_{d ( i )} {I}_{q ( i )} & \\ & {E}_{d ( i , γ + 1 )}^{′} = {E}_{d ( i , γ )}^{′} & {E}_{q ( i , γ + 1 )}^{′} = {E}_{q ( i , γ )}^{′} \\ & {\dot{δ}}_{( i , γ )} = {ω}_{b} [ {ω}_{( i , γ )}^{p} - 1 ] & \end{matrix} \\ {\dot{ω}}_{( i , γ )}^{p} = \frac{1}{2 {H}_{( i )}} [ {P}_{m ( i , γ )} - {P}_{e ( i , γ )} {GEN}_{MVA ( i )} - {D}_{( i )} ( {ω}_{( i , γ )}^{p} - 1 ) ] \\ {S}_{e ( i )} = [ {E}_{d ( i )} + j {E}_{q ( i )} ] [ {I}_{d ( i )} - j {I}_{q ( i )} ] ) {=}^{Δ} ( \overline{V} ℛ ) {( \overline{I} ℛ )}^{*}$$

$$\begin{matrix} \overline{V} ℛ = {E}_{d} + j {E}_{q} \\ = ( {E}_{d}^{′} + {X}_{d}^{′} {I}_{qg} ) + j ( {E}_{q}^{′} - {X}_{d}^{′} {I}_{dg} ) \\ = ( {E}_{d}^{′} + j {E}_{q}^{′} ) - j {X}_{d}^{′} ( {I}_{qg} + j {I}_{dg} ) \\ = {\overline{E}}^{′} ℛ - j {X}_{d}^{′} {\overline{I}}_{g} ℛ\end{matrix}$$

B. A “Clean” but Equivalent Version of Equations

For each generator at time step 1 (main):

$$\begin{matrix} & {GEN}_{MVA ( i )} ← \frac{{S}_{MVA}}{{GEN}_{MVA ( i )}} & \\ & {D}_{( i )} ← \frac{{D}_{( i )}}{{GEN}_{MVA ( i )}} & \\ & {H}_{( i )} ← \frac{{H}_{( i )}}{{GEN}_{MVA ( i )}} & \\ & \overline{V} = {E}_{T ( i )} {e}^{j {θ}_{( i )}} & \\ I = \sqrt{{P}_{e ( i , 1 )}^{2} + {Q}_{e ( i )}^{2}} / {E}_{T ( i )} \times & φ = {tan}^{- 1} ( \frac{{Q}_{e ( i )}}{{P}_{e ( i , 1 )}} ) & \overline{I} = I {e}^{j ( {θ}_{( i )} - φ )} \\ {GEN}_{MVA ( i )} & & \\ & \overline{E} = \overline{V} + j {X}_{d ( i )}^{′} \overline{I} & \\ {δ}_{( i , 1 )} = {tan}^{- 1} ( \frac{imag ( \overline{E} )}{real ( \overline{E} )} ) & {ω}_{( i , 1 )} = 0 & \\ & {E}_{q ( i )} = \vert {E}_{( i , 1 )} \vert & \\ & {P}_{m ( i , 1 )} = {P}_{e ( i , 1 )} & \end{matrix}$$

For each time step γ, for each generator i:

P_{m(i,γ+1)}=P_{m(i,γ)}

mac_em1 (machine to system reference frame):

E_{re(i,γ)}=cos δ_{(i,γ)}E′_{q(i)}

E_{im(i,γ)}=sin δ_{(i,γ)}E′_{q(i)}

After terminal voltage Ē(_{i,γ}) is obtained for all the buses, for each generator i:

i_simu_innerloop2 (system reference frame):

$${\overline{I}}_{( i , γ )} = {\sum }_{k} {\overline{Y}}_{( ik )} {\overline{E}}_{( k , γ )}$$

$${I}_{re ( i , γ )} = real [ {\overline{I}}_{( i , γ )} ]$$

$${I}_{im ( i , γ )} = imag [ {\overline{I}}_{( i , γ )} ]$$

mac_em2 (system to machine reference frame):

$${I}_{q ( i )} = cos {δ}_{( i , γ )} {I}_{re ( i , γ )} + sin {δ}_{( i , γ )} {I}_{im ( i , γ )}$$

$${P}_{e ( i , γ )} = {E}_{q ( i )}^{′} {I}_{q ( i )}$$

$${\dot{δ}}_{( i , γ )} = {ω}_{b} {ω}_{( i , γ )}$$

$${\dot{ω}}_{( i , γ )} = \frac{1}{2 {H}_{( i )}} [ {P}_{m ( i , γ )} - {P}_{e ( i , γ )} - {D}_{( i )} {ω}_{( i , γ )} ]$$

$${ω}_{( i , γ )}^{p} = {ω}_{( i , γ )} + 1$$

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

We claim:

1. A time-stacking method of simulating dynamics of a system so as to obtain time-domain trajectories which correspond to a disturbance or event, comprising:
a. providing a model for the system, wherein the model includes differential equations and algebraic equations; and
b. solving the differential equations and the algebraic equations over a predetermined number of time steps simultaneously using an implicit integration scheme.

2. The method of claim 1 further comprising applying a numerical solver to compute a final result of the equations.

3. The method of claim 2 further comprising applying a supercomputer or high-performance computer for solving the equations simultaneously in parallel.

4. The method of claim 1 wherein the implicit integration scheme comprises at least one of the following: Backward Euler, Trapezoidal, Runge-Kutta, Newton, and Dishonest Newton.

5. The method of claim 1 wherein the differential equations represent vectors of state variables and the algebraic equations represent vectors of algebraic variables.

6. The method of claim 5 wherein the vectors of state variables include generator dynamics.

7. The method of claim 6 wherein the generator dynamics include rotor angle and generator speed.

8. The method of claim 5 wherein the vectors of algebraic variables include voltages from selected buses in a network and current injections from generators or loads, expressed as magnitudes and phase angles, or real and imaginary parts.

9. The method of claim 1 wherein the time steps comprise intervals of at least 1 microsecond.

10. The method of claim 9 wherein the time steps of intervals vary over a range of at least 1 microsecond so as to obtain a calculation that corresponds to the disturbance or event.

11. A method of simulating power system dynamics of a system so as to obtain time-domain trajectories which correspond to a disturbance or event, comprising:
a. providing a model for the system, wherein the model includes differential equations and algebraic equations;
b. solving the differential equations and the algebraic equations over a predetermined number of time steps simultaneously using an implicit integration scheme;
c. applying a numerical solver to compute a final result of the equations; and
d. applying a supercomputer or high-performance computer for solving the equations simultaneously.

12. The method of claim 11 wherein the implicit integration scheme comprises at least one of the following: Backward Euler, Trapezoidal, Runge-Kutta, Newton, and Dishonest Newton.

13. The method of claim 11 wherein the differential equations represent vectors of state variables and the algebraic equations represent vectors of algebraic variables.

14. The method of claim 13 wherein the vectors of state variables include generator dynamics.

15. The method of claim 14 wherein the generator dynamics include rotor angle and generator speed.

16. The method of claim 13 wherein the vectors of algebraic variables include voltages from selected buses in a network and current injections from generators or loads, expressed as magnitudes and phase angles, or real and imaginary parts.

17. The method of claim 11 wherein the time steps comprise intervals of at least 1 microsecond.

18. The method of claim 17 wherein the time steps of intervals vary over a range of at least 1 microsecond so as to obtain a calculation that corresponds to the disturbance or event.
